(19) United States
(12) Patent Application Publication
(10) Pub. No.: US 2014/0267600 A1
(43) Pub. Date: Sep. 18, 2014

(54) SYNTH PACKET FOR INTERACTIVE VIEW NAVIGATION OF A SCENE

(71) Applicant: MICROSOFT CORPORATION, Redmond, WA (US)

(72) Inventors: Blaise Aguera y Arcas, Seattle, WA (US); Markus Unger, Graz (AT); Sudipta Narayan Sinha, Redmond, WA (US); Matthew T. Uyttendaele, Seattle, MA (US); Richard Stephen Szeliski, Bellevue, WA (US)

(73) Assignee: Microsoft Corporation, Redmond, WA (US)

(21) Appl. No.: 13/826,423

(22) Filed: Mar. 14, 2013

(51) Int. Cl. H04N 13/00

(52) U.S. Cl. CPC H04N 13/0011
USPC 348/42

(57) ABSTRACT

One or more techniques and/or systems are provided for generating a synth packet and/or for providing an interactive view experience of a scene utilizing the synth packet. In particular, the synth packet comprises a set of input images depicting a scene from various viewpoints, a local graph comprising navigational relationships between input images, a coarse geometry comprising a multi-dimensional representation of a surface of the scene, and/or a camera pose manifold specifying view perspectives of the scene. An interactive view experience of the scene may be provided using the synth packet, such that a user may seamlessly navigate the scene in multi-dimensional space based upon navigational relationship information specified within the local graph.

### BACKGROUND

Many users may create image data using various devices, such as digital cameras, tablets, mobile devices, smart phones, etc. For example, a user may capture a set of images depicting a beach using a mobile phone while on vacation. The user may organize the set of images to an album, a cloud-based photo sharing stream, a visualization, etc. In an example of a visualization, the set of images may be stitched together to create a panorama of a scene depicted by the set of images. In another example of a visualization, the set of images may be used to create a spin-movie. Unfortunately, navigating the visualization may be unintuitive and/or overly complex due to the set of images depicting the scene from various viewpoints.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for generating a synth packet and/or for providing an interactive view navigation experience utilizing the synth packet are provided herein.

In some embodiments of generating a synth packet, a navigation model associated with a set of input images depicting a scene may be identified. The navigation model may correspond to a capture pattern associated with positional information and/or rotational information of a camera used to capture the set of input images. For example, the capture pattern may correspond to one or more viewpoints from which the input images were captured. In an example, a user may walk down a street while taking pictures of building facades every few feet, which may correspond to a strafe capture pattern. In another example, a user may walk around a statue in a circular motion while taking pictures of the statue, which may correspond to a spin capture pattern.

A local graph structured according to the navigation model may be constructed. The local graph may specify relationship information between respective input images within the set of images. For example, the local graph may comprise a first node representing a first input image and a second node representing a second input image. A first edge may be created between the first node and the second node based upon the navigation model indicating that the second image has a relationship with the first image (e.g., the user may have taken the first image of the statue, walked a few feet, and then taken the second image of the statue, such that a current view of the scene may be visually navigated from the first image to the second image). The first edge may represent translational view information between the first input image and the second input image, which may be used to generate a translated view of the scene based upon image data contributed from the first image and the second image. In another example, the navigation model may indicate that a third image was taken from a viewpoint that is substantially far away from the viewpoint from which the first image and the second image were taken (e.g., the user may have to walk halfway around the statue before taking the third image). Thus, the first node and the second node may not be connected to a third node representing the third image within the local graph because visually navigating from the first image or the second image to the third image may result in various visual quality issues (e.g., blur, jumpiness, incorrect depiction of the scene, seam lines, and/or other visual error).

A synth packet comprising the set of input images and the local graph may be generated. The local graph may be used to navigate between the set of input images during an interactive view navigation of the scene (e.g., a visualization). A user may be capable of continuously navigating the scene in one-dimensional space and/or two-dimensional space using interactive view navigation input (e.g., one or more gestures on a touch device that translate into direct manipulation of a current view of the scene). The interactive view navigation of the scene may appear to the user as a single navigable visualization (e.g., a panorama, a spin movie around an object, moving down a corridor, etc.) as opposed to navigating between individual input images. In some embodiments, the synth packet comprises a camera pose manifold (e.g., view perspectives from which the scene may be viewed), a coarse geometry (e.g., a multi-dimensional representing of a surface of the scene upon which one or more input images may be projected), and/or other image information.

In some embodiments of providing an interactive view navigation experience, the synth packet comprises the set of input images, the camera pose manifold, the coarse geometry, and the local graph. The interactive view navigation experience may display one or more current views of the scene depicted by a set of input images (e.g., a facial view of the statue). The interactive view navigation experience may allow a user to continuously and/or seamlessly navigate the scene in multidimensional space based upon interactive view navigation input. For example, the user may visually “walk around” the statue as though the scene of the statue was a single multi-dimensional visualization, as opposed to visually transitioning between individual input images. The interactive view navigation experience may be provided based upon navigating the local graph within the synth packet. For example, responsive to receiving interactive view navigation input, the local graph may be navigated (e.g., traversed) from a first portion (e.g., a first node or a first edge) to a second portion (e.g., a second node or a second edge) based upon the interactive view navigation input (e.g., navigation from a first node, representing a first image depicting the face of the statue, to a second node representing a second image depicting a left side of the statue). The current view of the scene (e.g., the facial view of the statue) may be transitioned to a new current view of the scene corresponding to the second portion of the local graph (e.g., a view of the left side of the statue). Transitioning between nodes and/or edges may be translated into seamless three-dimensional navigation of the scene.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of generating a synth packet.

FIG. 2 is an example of one-dimensional navigation models.

FIG. 3 is an example of two-dimensional navigation models.

FIG. 4 is a component block diagram illustrating an exemplary system for generating a synth packet.

FIG. 5 is an example of providing a suggested camera position for a camera during capture of an input image.

FIG. 6 is a flow diagram illustrating an exemplary method of providing an interactive view navigation experience utilizing a synth packet.

FIG. 7 is a component block diagram illustrating an exemplary system for providing an interactive view navigation experience, such as a visualization of a scene, utilizing a synth packet.

FIG. 8 is an illustration of an exemplary computing device-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

An embodiment of generating a synth packet is illustrated by an exemplary method 100 of FIG. 1. At 102, the method starts. A set of input images may depict a scene (e.g., an exterior of a house) from various viewpoints. At 104, a navigation model associated with the set of input images may be identified. In an example, the navigation model may be identified based upon a user selection of the navigation model (e.g., one or more potential navigation models may be presented to a user for selection as the navigation model). In another example, the navigation model may be automatically generated based upon the set of input images. For example, a camera pose manifold may be estimated based upon the set of input images (e.g., various view perspectives of the house that may be constructed from the set of input images). A coarse geometry is constructed based upon the set of input images (e.g., based upon a structure from motion process; based upon depth information; etc.). The coarse geometry may comprise a multi-dimensional representation of a surface of the scene (e.g., a three-dimensional representation of the house, which may be textured by projecting the set of input images onto the coarse geometry to generate textured coarse geometry having texture information, such as color values). The navigation model may be identified based upon the camera pose manifold and the coarse geometry. The navigation model may indicate relationship information between input images (e.g., a first image was taken from a first view perspective depicting a front door portion of the house, and the first image is related to a second image that was taken from a second view perspective, a few feet from the first view perspective, depicting a front portion of the house slightly offset from the front door portion).

Because the set of input images may not depict every aspect of the scene at a desired quality and/or resolution, a suggested camera position, derived from the navigation model and one or more previously captured input images, may be provided during capture of an input image for inclusion within the set of input images. The suggested camera position may correspond to a view of the scene not depicted by the one or more previously captured input images. For example, the navigation model may correspond to spin capture pattern where a user walked around the house taking pictures of the house. However, the user may not have adequately captured a second story side view of the house, which may be identified based upon the spin capture pattern and the one or more previously captured input images of the house. Accordingly, a suggested camera position corresponding to the second story side view may be provided. In another example, a new input image may be automatically captured for inclusion within the set of input images based upon the new input image (e.g., a current camera view of the scene) depicting the scene from a view, associated with the navigation model, not depicted by the set of input images.

In an example, the navigation model may correspond to a capture pattern associated with positional information and/or rotational information of a camera used to capture at least one input image of the set of input images. The navigation model may be identified based upon the capture pattern. FIG. 2 illustrates an example 200 of one-dimensional navigation models. View perspectives of input images are represented by image views 210 and edges 212. A spin capture pattern 202 may correspond to a person walking around an object, such as a house, while capturing pictures of the object. A panoramic capture pattern 204 may correspond to a person standing in the middle of a room, and turning in a circle while capturing outward facing pictures of the room. A strafe capture pattern 206 may correspond to a person walking down a street while capturing pictures of building facades. A walking capture pattern 208 may correspond to a person walking down a hallway while capturing front-facing pictures down the hallway. FIG. 3 illustrates an example 300 of two-dimensional navigation models that are respectively derived from a combination of two one-dimensional navigation models, such as a spherical spin, a room of dioramas, a felled tree, the david, spherical pano, city block façade, totem pole, in wizard's tower, wall, stonehenge, cavern, shooting gallery, etc. For example, the cavern capture pattern may correspond to the walking capture pattern 208 (e.g., a person walking down a cavern corridor) and the panoramic capture pattern 204 (e.g., every 10 steps while walking down the cavern corridor, the user may capture images of the cavern while turning in a circle). It may be appreciated that merely a few examples of one-dimensional navigation models and two-dimensional navigation models are illustrated, and that other capture patterns are contemplated. It may be appreciated that higher order navigation models, such as three-dimensional navigation models, may be used.

At 106, a local graph is constructed. The local graph is structured according to the navigation model (e.g., the navigation model may provide insight into how to navigate from a first input image to a second input image because the first input image and the second input image were taken from relatively similar viewpoints of the scene; how to create a current view of the scene from a transitional view corresponding to multiple input images; and/or that navigating from the first input image to a third input image may produce visual error because the first input image and the third input image were taken from relatively different viewpoints of the scene). The local graph may specify relationship information between respective input images within the set of input images, which may be used during navigation of the scene. For example, a current view may correspond to a front portion of a house depicted by a first input image. Interactive view navigation input corresponding to a rotational sweep from the front portion of the house to a side portion of the house may be detected. The local graph may comprise relationship information indicating that a second input image (e.g., or a translational view derived from multiple input images being projected onto a coarse geometry) may be used to provide a new current view of depicting the side portion of the house.

In an example, the local graph comprises one or more nodes connected by one or more edges. For example, the local graph comprise a first node representing a first input image (e.g., depicting the front portion of the house), a second node representing a second input image (e.g., depicting the side portion of the house), a third node representing a third input image (e.g., depicting a back portion of the house), and/or other nodes. A first edge may be created between the first node and the second node based upon the navigation model specifying a view navigation relationship between the first image and the second image (e.g., the first input image and the second input image were taken from relatively similar viewpoints of the scene). However, the first node may not be connected to the third node by an edge based upon the navigation model (e.g., the first input image and the third input image were taking from relatively different viewpoints of the scene). In an example, a current view of the front portion of the house may be seamlessly navigated to a new current view of the side portion of the house (e.g., the first image may be displayed, then one or more transitional views based upon the first image and the second image may be displayed, and finally the second image may be displayed) based upon traversing the local graph from the first node to the second node along the first edge. Because the local graph does not have an edge between the first node and the third node, the current view of the front portion of the house cannot be directly transitioned to the back portion of the house, which may otherwise produce visual errors and/or a “jagged or jumpy” transition. Instead, the graph may be traversed from the first node to the second node, and then from the second node to the third node based upon a second edge connecting the second node to the third node (e.g., the first image may be displayed, then one or more transitional views between the first image and the second image may be displayed, then the second image may be displayed, then one or more transitional views between the second image and the third image may be displayed, and then finally the third image may be displayed). In this way, a user may seamlessly navigate and/or explore the scene of the house by transitioning between input images along edges connecting nodes representing such images within the local graph.

At 108, a synth packet comprising the set of input images and the local graph is generated. In some embodiments, the synth packet comprises a single file (e.g., a file comprising information that may be used to construct a visualization of the scene and/or provide a user with an interactive view navigation of the scene). In some embodiments, the synth packet comprises the camera pose manifold and/or the coarse geometry. The synth packet may be used to provide an interactive view navigation experience, as illustrated by FIG. 6 and/or FIG. 7. At 110, the method ends.

FIG. 4 illustrates an example of a system 400 configured for generating a synth packet 408. The system 400 comprises a packet generation component 404. The packet generation component 404 is configured to identify a navigation model associated with a set of input images 402. For example, the navigation model may be automatically identified or manually selected from navigation models 406. The packet generation component 404 may be configured to construct a local graph 414 structured according to the navigation model. For example, the navigation model may correspond to viewpoints of the scene from which respective input images were captured (e.g., the navigation model may be derived from positional information and/or rotational information of a camera). The viewpoint information within the navigation model may be used to derive relationship information between respective input images. For example, a first input image depicting a first story outside portion of a house from a northern viewpoint may have a relatively high correspondence to a second input image depicting a second story outside portion of the house from a northern viewpoint (e.g., during an interactive view navigation experience of the house, a current view of the first story may be seamlessly transitioned to a new current view of the second story based upon a transition between the first image and the second image). In contrast, the first input image and/or the second input image may have a relatively low correspondence to a fifth input image depicting a porch of the house from a southern viewpoint. In this way, the local graph 414 may be constructed according to the navigation model where nodes represent input images and edges represent translational view information between input images.

In some embodiments, the packet generation component 404 is configured to construct a coarse geometry 412 of the scene. Because the coarse geometry 412 may initially represent a non-textured multi-dimensional surface of the scene, one or more input images within the set of input images 402 may be projected onto the coarse geometry 412 to texture (e.g., assign color values to geometry pixels) the coarse geometry, resulting in textured coarse geometry. Because a current view of the scene may not directly correspond to a single input image, the current view may be derived from the coarse geometry 412 (e.g., the textured coarse geometry) from a view perspective defined by the camera pose manifold 410. In this way, the packet generation component 404 may generate the synth packet 408 comprising the set of input images 402, the camera pose manifold 410, the coarse geometry 412, and/or the local graph 414. The synth packet 408 may be used to provide an interactive view navigation experience of the scene. For example, a user may visually explore the outside of the house in three-dimensional space as though the house were represented by a single visualization, as opposed to individual input images (e.g., one or more current views of the scene may be constructed by navigating the local graph 414).

FIG. 5 illustrates an example 500 of providing a suggested camera position and/or orientation 504 for a camera 502 during capture of an input image. That is, one or more previously captured input images may depict a scene from various viewpoints. Because the previously captured input images may not cover every viewpoint of the scene (e.g., a northern facing portion of a building and a tree may not be adequately depicted by the previously captured images), the suggested camera position and/or orientation 504 may be provided to aid a user in capturing one or more input images from viewpoints of the scene not depicted by the previously captured images. The suggested camera position and/or orientation 504 may be derived from a navigation model, which may be indicative of the viewpoints already covered by the previously captured images. In an example of the suggested camera position and/or orientation 504, instructions (e.g., an arrow, text, and/or other interface elements) may be provided through the camera 502, which instruct the user to walk east, and then capture pictures while turning in a circle so that northern facing portions of the building and the tree are adequately depicted by such pictures.

An embodiment of providing an interactive view navigation experience utilizing a synth packet is illustrated by an exemplary method 600 of FIG. 6. That is, the synth packet (e.g., a single file that may be consumed by an image viewing interface) may comprise a set of input images depicting a scene. As opposed to merely being a set of unstructured input images that a user may “flip through”, the set of input images may be structured according to a local graph comprised within the synth packet (e.g., the local graph may specify navigational relationships between input images). The local graph may represent images as nodes. Edges between nodes may represent navigational relationships between images. In some embodiments, the synth packet comprises a coarse geometry onto which the set of input images may be projected to create textured coarse geometry. Because a current view of the scene, provided by the view navigation experience, may not directly correspond to a single input image, the current view may be generated from a translational view corresponding to a projection of multiple input images onto the coarse geometry from a view perspective defined by a camera pose manifold within the synth packet.

The view navigation experience may correspond to a presentation of an interactive visualization (e.g., a panorama, a spin movie, a multi-dimensional space representing the scene, etc.) that a user may navigate in multi-dimensional space to explore the scene depicted by the set of input images. The view navigation experience may provide a 3D experience by navigating from input image to input image, along edges within the local graph, in 3D space (e.g., allowing continuous navigation between input images as though the visualization of the scene was a single navigable entity as opposed to individual input images). That is, the set of input images within the synth packet may be continuously and/or intuitively navigable as a single visualization unit (e.g., a user may continuously navigate through the scene by merely swiping across the visualization, and may intuitively navigate through the scene where navigation input may translate into direct navigation manipulation of the scene). In particular, the scene may be explored as a single visualization because the set of input images are represented on a single continuous manifold within a simple topology, such as the local graph (e.g., spinning around an object, looking at a panorama, moving down a corridor, and/or other visual navigation experiences of a single visualization). Navigation may be simplified because the dimensionality of the scene may be reduced to merely one or more dimensions of the local graph. Thus, navigation of complex image configurations may become feasible on various computing devices, such as a touch device where a user may navigate in 3D space using left/right gestures for navigation in a first dimension and up/down gestures for navigation in a second dimension. The user may be able to zoom into areas and/or navigate to a second scene depicted by second synth packet using other gestures, for example.

At 602, the method starts. At 604, an interactive view navigation input associated with the interactive view navigation experience may be received. At 606, the local graph may be navigated from a first portion of the local graph (e.g., a first node representing a first image used to generate a current view of the scene; a first edge representing a translated view of the scene derived from a projection of one or more input images onto the coarse geometry from a view perspective defined by the camera pose manifold; etc.) to a second portion of the local graph (e.g., a second node representing a second image that may depict the scene from a viewpoint corresponding to the interactive view navigation input; a second edge representing a translated view depicting the scene from a viewpoint corresponding to the interactive view navigation input; etc.) based upon the interactive view navigation. In an example, a current view of a northern side of a house may have been derived from a first input image represented by a first node. A first edge may connect the first node to a second node representing a second input image depicting a northeastern side of the house. For example, the first edge may connect the first node and the second node because the first image and the second image were captures from relatively similar viewpoints of the house. The first edge may be traversed to the second node because the interactive view navigation input may correspond to a navigation of the scene from the northern side of the house to a northeastern side of the house (e.g., a simple gesture may be used to seamlessly navigate to the northeastern side of the house from the northeastern side). At 608, a current view of the scene (e.g., depicting the northern side of the house) corresponding to the first portion of the local graph may be transitioned to a new current view of the scene (e.g., depicting the northeastern side of the house) corresponding to the second portion of the local graph.

In an example, the interactive view navigation input corresponds to the second node within the local graph. Accordingly, the new current view is displayed based upon the second image represented by the second node. In another example, the interactive view navigation input corresponds to the first edge connecting the first node and the second node. The new current view may be displayed based upon a projection of the first image, the second image and/or other images onto the coarse geometry (e.g., thus generating a textured coarse geometry) utilizing the camera pose manifold. The new current view may correspond to a view of the textured coarse geometry from a view perspective defined by the camera pose manifold. At 610, the method ends.

FIG. 7 illustrates an example of a system 700 configured for providing an interactive view navigation experience, such as a visualization 706 of a scene, utilizing a synth packet 702. The synth packet 702 may comprise a set of input images depicting a house and outdoor scene. For example, a first input image 708 depicts the house and a portion of a cloud, a second input image 710 depicts a portion of the cloud and a portion of a sun, a third input image 712 depicts a portion of the sun and a tree, etc. It may be appreciated that the set of input images may comprise other images, such as overlapping images (e.g., multi-dimensional overlap), that are captured from various viewpoints, and that example 700 merely illustrates non-overlapping two-dimensional images for simplicity. The synth packet 702 may comprise a coarse geometry, a local graph, and/or a camera pose manifold that may be used to provide the interactive view navigation experience.

The system 700 may comprise an image viewing interface component 704. The image viewing interface component 704 may be configured to display a current view of the scene based upon navigation within the visualization 706. It may be appreciated that in an example, navigation of the visualization 706 may correspond to multi-dimensional navigation, such as three-dimensional navigation, and that merely one-dimensional and/or two-dimensional navigation are illustrated for simplicity. The current view may correspond to a second node, representing the second input image 710 depicting the portion of the cloud and the portion of the sun, within the local graph. Responsive to receiving interactive view navigation input 716 (e.g., a gesture swiping right across a touch device), the local graph may be traversed from the second node, across a second edge, to a third node representing the third image 712. A new current view may be displayed based upon the third image 712. In this way, a user may seamlessly navigate the visualization 706 as though the visualization 706 was a single navigable entity (e.g., based upon structured movement along edges and/or between nodes within the local graph) as opposed to individual input images.

Still another embodiment involves a computer-readable medium comprising processor-executable instructions configured to implement one or more of the techniques presented herein. An example embodiment of a computer-readable medium or a computer-readable device that is devised in these ways is illustrated in FIG. 8, wherein the implementation 800 comprises a computer-readable medium 808, such as a CD-R, DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the processor-executable computer instructions 804 are configured to perform a method 802, such as at least some of the exemplary method 100 of FIG. 1 and/or at least some of the exemplary method 600 of FIG. 6, for example. In some embodiments, the processor-executable instructions 804 are configured to implement a system, such as at least some of the exemplary system 400 of FIG. 4 and/or at least some of the exemplary system 700 of FIG. 7, for example. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component is localized on one computer or distributed between two or more computers.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 9 and the following discussion provide a brief, general description of a suitable computing environment to implement embodiments of one or more of the provisions set forth herein. The operating environment of FIG. 9 is only an example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions are implemented as program modules, such as functions, objects, Application Programming Interfaces (APIs), data structures, and the like, that perform particular tasks or implement particular abstract data types. Typically, the functionality of the computer readable instructions are combined or distributed as desired in various environments.

FIG. 9 illustrates an example of a system 900 comprising a computing device 912 configured to implement one or more embodiments provided herein. In one configuration, computing device 912 includes at least one processing unit 916 and memory 918. In some embodiments, depending on the exact configuration and type of computing device, memory 918 is volatile, such as RAM, non-volatile, such as ROM, flash memory, etc., or some combination of the two. This configuration is illustrated in FIG. 9 by dashed line 914.

In other embodiments, device 912 includes additional features or functionality. For example, device 912 also includes additional storage such as removable storage or non-removable storage, including, but not limited to, magnetic storage, optical storage, and the like. Such additional storage is illustrated in FIG. 9 by storage 920. In some embodiments, computer readable instructions to implement one or more embodiments provided herein are in storage 920. Storage 920 also stores other computer readable instructions to implement an operating system, an application program, and the like. Computer readable instructions are loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media is part of device 912.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 912 includes input device(s) 924 such as keyboard, mouse, pen, voice input device, touch input device, infrared cameras, video input devices, or any other input device. Output device(s) 922 such as one or more displays, speakers, printers, or any other output device are also included in device 912. Input device(s) 924 and output device(s) 922 are connected to device 912 via a wired connection, wireless connection, or any combination thereof. In some embodiments, an input device or an output device from another computing device are used as input device(s) 924 or output device(s) 922 for computing device 912. Device 912 also includes communication connection(s) 926 to facilitate communications with one or more other devices.

Although the subject matter has been described in language specific to structural features and/or methodological acts, it is to be understood that the subject matter of the appended claims is not necessarily limited to the specific features or acts described above. Rather, the specific features and acts described above are disclosed as example forms of implementing the claims.

Various operations of embodiments are provided herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

It will be appreciated that layers, features, elements, etc. depicted herein are illustrated with particular dimensions relative to one another, such as structural dimensions and/or orientations, for example, for purposes of simplicity and ease of understanding and that actual dimensions of the same differ substantially from that illustrated herein, in some embodiments.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims.

What is claimed is:

1. A method for providing an interactive view navigation experience utilizing a synth packet, comprising:
providing an interactive view navigation experience utilizing a synth packet comprising at least one of a set of input images depicting a scene, a camera pose manifold, a coarse geometry corresponding to a multi-dimensional representation of a surface of the scene, or a local graph specifying navigational relationship information between respective input images within the set of input images, the providing comprising:
responsive to receiving an interactive view navigation input associated with the interactive view navigation experience:
navigating from a first portion of the local graph of the synth packet to a second portion of the local graph; and
transitioning a current view of the scene, corresponding to the first portion of the local graph, to a new current view of the scene corresponding to the second portion of the local graph, the transitioning corresponding to three-dimensional navigation of the scene.

2. The method of claim 1, the providing an interactive view navigation experience comprising:
responsive to the interactive view navigation input corresponding to a first node within the local graph, displaying the new current view based upon a first image represented by the first node;
responsive to the interactive view navigation input corresponding to a second node within the local graph, displaying the new current view based upon a second image represented by the second node; and
responsive to the view navigation corresponding to a first edge between the first node and the second node, displaying the new current view as a translated view based upon a projection of the first image and the second image onto the coarse geometry utilizing the camera pose manifold.

3. The method of claim 1, the current view of the scene derived from a current node within the local graph, and the method comprising:
responsive to the interactive view navigation input corresponding to a non-neighboring node that is not connected to the current node by an edge, refraining from displaying a non-neighboring image represented by the non-neighboring node.

4. A method for generating a synth packet, comprising:
identifying a navigation model associated with a set of input images depicting a scene;
constructing a local graph structured according to the navigation model, the local graph specifying relationship information between respective input images within the set of input images, the local graph comprising a first node representing a first input image, a second node representing a second input image, and a first edge between the first node and a second node, the first edge representing translational view information between the first input image and the second input image; and
generating a synth packet comprising the set of input images and the local graph.

5. The method of claim 4, comprising:
estimating a camera pose manifold, for inclusion within the synth packet, based upon the set of input images.

6. The method of claim 4, comprising:
constructing a coarse geometry, for inclusion within the synth packet, based upon the set of input images, the coarse geometry corresponding to a multi-dimensional representation of a surface of the scene.

7. The method of claim 4, the identifying a navigation model comprising:
determining a capture pattern associated with at least one of positional information or rotational information of a camera used to capture at least one input image of the set of input images; and
identifying the navigation model based upon the capture pattern.

8. The method of claim 4, the constructing a local graph comprising:
creating the first edge between the first node and the second node based upon the navigation model specifying a view navigation relationship between the first image and the second image.

9. The method of claim 8, the view navigation relationship corresponding to at least one of a one-dimensional navigation input or a multi-dimensional navigation input used to translate between the first image and the second image using an image viewing interface.

10. The method of claim 4, comprising:
providing an interactive view navigation experience utilizing the synth packet, the providing comprising:
responsive to receiving a gesture associated with the interactive view navigation experience:
navigating from a first portion of the local graph of the synth packet to a second portion of the local graph; and
transitioning a current view of the scene, corresponding to the first portion of the local graph, to a new current view of the scene corresponding to the second portion of the local graph, the transitioning corresponding to three-dimensional navigation of the scene.

11. The method of claim 7, the capture pattern corresponding to a one dimensional capture pattern comprising at least one of a spin capture pattern, a panoramic capture pattern, a strafe capture pattern, or a walking capture pattern.

12. The method of claim 7, the capture pattern corresponding to a two dimensional capture pattern comprising a cross product between a first one dimensional capture pattern and a second one dimensional capture pattern, at least one of the first one dimensional capture pattern or the second one dimensional capture pattern comprising at least one of a spin capture pattern, a panoramic capture pattern, a strafe capture pattern, or a walking capture pattern.

13. The method of claim 4, comprising:
during view navigation of the scene utilizing the synth packet, facilitating a navigation input based upon the navigation input corresponding to a node or an edge of the local graph.

14. The method of claim 13, the facilitating a navigation input comprising:
responsive to the view navigation corresponding to the first node, displaying a first view based upon the first image;
responsive to the view navigation corresponding to the second node, displaying a second view based upon the second image; or
responsive to the view navigation corresponding to the first edge, displaying a translated view based upon a projection of the first image and a projection of the second image projected onto a coarse geometry comprised within the synth packet.

15. The method of claim 4, comprising:
during capture of an input image for inclusion within the set of input images, providing at least one of a suggested camera position or a suggested camera orientation based upon the navigation model and one or more previously captured input images.

16. The method of claim 4, the identifying a navigation model comprising at least one of:
identifying the navigation model based upon a user selection of the navigation model; or
automatically generating the navigation model based upon the set of input images.

17. The method of claim 16, the automatically generating the navigation model comprising:
estimating a camera pose manifold based upon the set of input images;
constructing a coarse geometry based upon the set of input images; and
identifying the navigation model based upon the camera pose manifold and the coarse geometry.

18. The method of claim 4, comprising:
automatically capturing a new input image for inclusion within the set of input images based upon the new input image depicting the scene from a view, associated with the navigation model, not depicted by the set of input images.

19. A system for generating a synth packet, comprising:
a packet generation component configured to:
identify a navigation model associated with a set of input images depicting a scene;
construct a local graph structured according to the navigation model, the local graph specifying relationship information between respective input images within the set of input images, the local graph comprising a first node representing a first input image, a second node representing a second input image, and a first edge between the first node and a second node, the first edge representing translational view information between the first input image and the second input image; and
generate a synth packet comprising the set of input images and the local graph.

20. The system of claim 19, comprising:
a image viewing interface component configured to:
provide an interactive view navigation experience utilizing the synth packet, comprising:
responsive to receiving a gesture associated with the interactive view navigation experience:
navigate from a first portion of the local graph of the synth packet to a second portion of the local graph; and
transition a current view of the scene, corresponding to the first portion of the local graph, to a new current view of the scene corresponding to the second portion of the local graph, the transitioning corresponding to three-dimensional navigation of the scene.
